(19) United States
(12) Patent Application Publication
(10) Pub. No.: US 2008/0095430 A1
(43) Pub. Date: Apr. 24, 2008

(54) Maintenance of Color Maximum Values in a Color Saturation Controlled Color Image

(75) Inventor: Cornelis Antonie Maria Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,145

(22) PCT Filed: Jul. 8, 2005
(86) PCT No.: PCT/IB05/52277

§ 371 Date: Jan. 16, 2007

(30) Foreign Application Priority Data
Jul. 20, 2004 (EP) 04103454.7

(51) Int. Cl. G06K 9/00

(52) U.S. Cl. 382/167

(57) ABSTRACT

Conventional color saturation control CSC in a non-linear signal domain may result in exaggerated and unnatural looking colors. The invention proposes an image signal processing method (30A, 30B) of a color saturation control (17) which applies a gain value (27) to the saturation controlled image signal (Y′, satx(R′-Y′), satx(B′-Y′)) in a color restoration (10) which results in an output signal (Yo′, (R′-Y′)o, (B′-Y′)o). The gain value (27) is determined such that a maximum value of a color in the input signal is maintained in the output signal (Yo′, (R′-Y′)o, (B′-Y′)o). Thereby in particular the symmetry of the 3Dcolor space is maintained, preferably by controlling at least the maximum values of three primary colors (R, G, B) when increasing the saturation. In a preferred configuration the saturation controlled color difference image signals (satx(R′-Y′), satx(B′-Y′)) are transformed to the RGB-domain to obtain an RGB-measure of the increased saturation. Also the color difference input image signals (R′-Y′, B′-Y′) are transformed to analyze the original level of saturation. On this basis a first (RGBmaxsat′) and a second (RGBmax′) color maximum value are determined and used to determine the gain value (27).

### FIELD OF THE INVENTION

The present invention relates to an image signal processing method of controlling a color saturation for an image and a respective image signal processing device, apparatus, computer program product.

Contemporary image signal processing techniques usually have to apply specific control means to control a hue or a saturation or a lightness of an image upon image signal processing to avoid abnormal or exaggerated image parameters. In a color display device, the saturation of the colors in the displayed image may be increased by means of a saturation control. In current television sets and other apparatuses processing images user color saturation is performed in a non-linear signal domain due to the camera conversion inherent of the camera capturing the images. This non-linear camera signal is the reason why an increase of the saturation results in displaying of some colors, especially blue and red, in an exaggerated way and some, especially yellow, in a poor way.

### BACKGROUND OF THE INVENTION

In the prior art the solutions offered e.g. as a dynamic control of EP 0 920 196 A2 or a contrast control of WO 02/085 037 A1 have another focus and are insufficient to avoid the above mentioned problems.

In particular in WO 2004/008778 A1 a method of picture processing for a display device is disclosed wherein input picture signals are processed in a non-linear manner. The processing can serve to limit or in some cases avoid clipping of the output signal. This can be achieved by increasing the saturation up to a maximum level at which clipping does not yet take place. Use is made of amongst others, the hue values to determine this maximum saturation level. Thereby a color saturation of the output picture signal can be controlled in a manner to avoid a loss of picture details because the color saturation is increased more for picture areas showing low saturation levels than for picture areas showing high saturation levels. Nevertheless oversaturated colors are not strictly prevented and are taken into account for some cases as the hue is determined only roughly and also the luminance is used to determine the maximum saturation level. This may result in the described exaggerated and unnatural looking color effects.

In EP 1 383 341 A2 a method and an apparatus for adaptively enhancing a color of an image are provided. The method comprises the steps of converting an input image represented in a first color space into an image in a second color space and determining a saturation function based on the characteristics of the input image. However, the determining step comprises extracting an average saturation of the input image from color signals of the input image and determining a saturation enhancement function determining variable based on the average saturation. In practice this means a desired average level is set in comparison to the measure of the average of the picture. If the average of the picture is lower than the desired average level an increase in the color saturation will be effected. If the average of the picture is higher than the desired average level a decrease of the color saturation will be effected. This method will be considerably successful in improving the color characteristics of an image, however, will also fail in a considerable number of cases as oversaturated colors are not strictly prevented. The described teaching may work well when an automatic saturation control is applied, however, when a user controlled saturation is applied again exaggerated and unnatural looking colors can occur as they are not strictly prevented.

Desirable is a concept wherein exaggerated and unnatural looking colors are strictly prevented even in case of high saturation levels of conventional color saturation control. In particular exaggerated colors near red and magenta should be prevented and colors near yellow should be improved.

### SUMMARY OF THE INVENTION

This is where the invention comes in, the object of which is to provide an image signal processing method of controlling a color saturation for an image and an image signal processing apparatus for controlling a color saturation for an image which effectively and reliably prevents exaggerated and unnatural looking colors, which arise from changing a saturation control for the image to be displayed.

As regards the method the object is achieved by an image signal processing method of controlling a color saturation for an image, the method comprising the steps of:

providing an input image signal;

applying a saturation control to the input image signal resulting in a saturation controlled image signal;

applying a gain value to the saturation controlled image signal in a color restoration resulting in an output signal; wherein

the gain value is determined such that a maximum value of a color in the input signal is maintained in the output signal.

The invention has realized, that a maximum value of a color, i.e. the maximum RGB value of the border colors of a gamut, can be kept equal before and after a saturation control only if the saturation control is corrected by means of a gain value. The main concept proposed by the invention is to determine said gain value such that a maximum value of a color in the input signal is strictly maintained in the output signal. As a consequence in particular also a maximum light output of the corresponding primary color at the output of the display is strictly maintained. The invention can also imply that the colors between the border of a color gamut and the center of the color gamut (i.e. those colors having a value lower than a maximum value) can be, however must not be, adapted according to an original saturation controlled parameter. The colors between the border and the center of a color gamut may also be adapted according to a saturation control parameter and a preferably adapted gain value, e.g. an adapted gain value below the one of the border colors according to the invention. A proper interpolation can be implied. In any case a maximum value of a color in the input signal, i.e. the value of the border colors of the color gamut, are equal before and after a saturation control.

As compared to commonplace measures a variety of advantages are achieved by the main concept. It is directly apparent from the concept, that a unique gain value is applied for all relevant colors and will result in a symmetrical adaptation of a color value. This means, that the proposed method, even at an increasing color saturation control, will keep the symmetry of the 3D-color space. As the maximum value of a color is perfectly maintained also the symmetry of the 3D-color space is perfectly maintained. From a perception point of view this so called “Equal Color Maximum Value Method” results in a very well balanced and rich color reproduction with a very natural and simultaneous change of all colors. In contradistinction a conventional method of color saturation control still may cause exaggerated and unnatural blue, red and magenta colors and poor yellow colors. Moreover the poor green and cyan and the very poor yellow color reproduction of conventional methods are prevented and instead a very well balanced display of all colors is possible by maintaining a maximum value of a color of the input signal and maintaining the symmetry of the 3D-color space.

In particular investments and development activities for displays are superfluous, which usually have to provide a variety of different kinds of measures to limit the amount of the change of saturation or other activities for displays with other or extra primary colors in order to obtain a better (for instance yellow) color reproduction. In particular, applying of Lab, CbCr, HSV and so on color space parameters as disclosed in EP 1 383 341 A2 is superfluous. Even though its a rather complicated concept, the teaching of EP 1 383 341 A2 will work merely with an automatic saturation control. The present invention however will also work advantageously in case of a user controlled saturation. This is because in any case a maximum value of a color in the input signal is strictly maintained in the output signal. Consequently the present invention in particular provides can be understood as an improved alternative to conventional color saturation control methods.

Also the concept of the present invention may be flexibly adapted in accordance with developed configurations of the invention, which are further outlined in the dependent claims.

The invention is suited for modem plasma display panels as well as LCD-applications, cameras, computer applications and color printers and computer software applications.

Particularly the gain value is applied by multiplying the saturation controlled image signal with the gain value.

In a particular preferred configuration the maximum value is maintained for all colors having a same maximum input value in the input signal. In particular this is the case for the maximum value of one or more selected reference colors. In particularly preferred configuration the one or more selected reference colors comprise at least three primary colors. In general the one or more selected reference colors may comprise any kind of color, however, in view of contemporary applications the selected reference colors comprise at least red, green and blue. In other words, the advantages of the above mentioned concept are realized preferably best by controlling the maximum of the three primary colors when increasing the saturation.

In a further developed configuration also at least three complementary colors may be comprised by the one or more selected reference colors, in particular yellow, magenta and cyan. A particular advantageous way of selecting the reference colors is outlined in the Appendix of the detailed description.

In a particular preferred configuration the color restoration comprises the further steps of,

in a first processing stream:

transforming the saturation controlled image signal into a saturation controlled RGB-image signal;

determining a first maximum value from the saturation controlled RGB-image signal; and

in a second processing stream:

transforming the input image signal into a RGB-image signal;

determining a second maximum value from the RGB-image signal.

To this end a color difference signal after saturation increase is transformed to the RGB domain to obtain a “RGB measure” of the increased saturation. Furthermore also an original color difference signal is transformed to the RGB domain to analyze the “original level of saturation”. The method of the new concept therefore will also be denoted by “EqualRGBmax color saturation method”.

Consequently a preferred configuration comprises the step of determining the gain value in general from the first maximum value and/or the second maximum value. I.e. a correction factor in form of a gain value is determined for the color difference signals after saturation increase. In other words, the gain value is determined on the basis of the above-mentioned “RGB-measure” of saturation increase and the above-mentioned “original level of saturation”.

Such measure is e.g. in contradistinction to the teaching of WO 2004/00878 A1, wherein the luminance signal has been used for the calculations and no compensation for the cone shape of the 3D-space is provided.

The developed configurations have been adapted in particular for a RGB color space. Here in a simplified configuration the gain value is affected by a quotient of the second and the first maximum value. The concept of the invention may be in particular also applied in the HSV color space (Hue saturation value), which is advantageously used in computer software applications.

In this case the gain value is preferably determined by the quotient of the second maximum value and the first maximum value. A particular preferred second embodiment is described with reference to FIG. 11 in the detailed description.

In particular with regard to the RGB colorspace in a further developed configuration the method comprises the step of determining the gain value further by means of a measure of true saturation. In particular the step of determining the gain value also comprises the further steps of

detecting a minimum color value from the RGB-image signal, and

calculating a true saturation parameter from the maximum color value and the minimum color value.

Most preferably the measure of true saturation provides a difference between the second maximum value and a minimum value from the RGB-image signal. In particular said measure of true saturation can be divided by the second maximum value. A particular preferred detail of a first embodiment is described in reference to Equ. 8, 11 and FIG. 6 in the detailed description.

Advantageously by these measures a proportional and for all colors symmetrical increase is provided as a function of saturation control.

In accordance with a further preferred configuration the gain value gives a comparison, in particular a quotient, of the second and the first maximum value. A particular preferred first embodiment is given with reference to Equ. 10 and FIG. 6 in the detailed description. In particular said quotient will be multiplied by the true saturation parameter as mentioned above. A final gain value according to the first embodiment as a function of the color saturation control is given in Equ. 11 in the detailed description.

In accordance with a preferred first aspect of the invention preferably an average of the second maximum value is used instead of the second maximum value to determine the gain value. In particular determining the gain value comprises the further step of calculating an average value from the above mentioned second maximum value. A preferred embodiment is described in the detailed description with reference to FIG. 6 and Equ. 9 and 14.

In a preferred and elaborated configuration of the first aspect the average is determined from one or more maximum values of the selected reference colors as mentioned above. A particular preferred embodiment is described with reference to Equ. 9. In particular the one or more selected colors are selected in a color gamut by means of a sequence of intersecting lines. In particular the intersecting lines intersect with lines between primary and/or complementary colors. A particular advantageous way of finding preferred border colors for averaging is described with reference to the Appendix in the detailed description. Preferably up to 30 or 70 border colors, i.e. maximum color values of colors in a gamut of preferred kind can be calculated to achieve a very good result. This former elaborated configuration may be applied in case of a defined camera gamma as described in Sec. 2 of the detailed description with reference to FIG. 2. This latter more simple configuration may be preferred in case of an unknown camera gamma as described in Sec. 3 of the detailed description with reference to FIG. 5.

In a simpler and still preferable configuration of the first aspect the average may be also determined from one or more maximum values of an arbitrary reference color. A particular preferred embodiment is described with reference to Equ. 14.

In accordance with a preferred second aspect of the invention the method also comprises the step of limiting the average of the second maximum value. In particular the step of limiting is applied as a function of one or more maximum values of an arbitrary reference color and/or by an adjustment of the saturation control. A particular preferred embodiment is described with reference to Equ. 15 and Sec. 4 of the detailed description. Limiting of the average is particular preferred as the second aspect can be adapted in dependence of a display type. A proper limiting look-up table (LUT) may be selected for a cathode ray tube (CRT) or a plasma display panel (PDP) on the one hand. On the other hand a different limiting (LUT) may be provided in case of a liquid crystal display (LCD) or a digitally stored or a printed picture (DIG). Preferably the latter will have lower output values than the former as a LCD or DIG device has limited lightness values as compared to a CRT or a PDP device.

The method and developed configurations thereof as outlined above may be implemented by digital circuits of any preferred kind, whereby the advantages associated with digital circuits may be obtained. A single processor or other unit may fulfill the functions of several means recited in the claims or outlined in the description or shown in the figures.

Consequently with regard to the apparatus, the invention also leads to a signal processing device for controlling a color saturation for an image said device comprising:

means for providing an input image signal;

means for applying a saturation control to the input image signal resulting in a saturation controlled image signal;

color restoration means for applying a gain value to the saturation controlled image signal resulting in an output signal;

means for determining the gain value such that a maximum value of a color in the input signal is maintained in the output signal.

Preferred embodiments of the apparatus may be taken also from FIG. 6 and FIG. 11 of the detailed description. In particular with regard to the apparatus the invention also leads to an apparatus comprising a display and a signal processing device, wherein the signal processing device is adapted to perform the method as mentioned above. In particular a display may be selected from the group consisting of a cathode ray tube (CRT), liquid crystal display (LCD), plasma display panel (PDP). A display of the mentioned kind may be used in particular in a camera or in form of a monitor, in particular for a computer or a television.

The invention also leads to a computer program product storable on a medium readable by a computing device comprising a software code section which induces the computing device to execute the method as described above when the product is executed on the computing device. Preferred configuration of software code sections to an averaging of the second maximum value to determine an average and limiting the average as mentioned above.

The invention also leads to a computing and/or storage device for executing and/or storing the computer program product as described above. A particular preferred computing device is adapted to perform the above-mentioned averaging of the second maximum value to determine an average and limiting the average as mentioned above.

These and other aspects of the invention will be apparent from and elucidated with reference to the preferred embodiments described hereinafter. It is, of course, not possible to describe every conceivable configuration of the components or methodologies for purposes of describing the present invention but one of ordinary skill in the art will recognize that many further combinations and permutations of the present inventions are possible.

Usually such techniques described above apply for television sets or digital still and video cameras. Whereas the invention has particular utility for and will be described as associated with a display it should be understood that the concept of the invention is also operable with other forms of an output device for outputting color images. For example the concept of the invention may also be applied to a color printer or many computer applications.

Image signal processing meanwhile has become a relevant part of consumer electronics, in particular also digital consumer equipment and all kinds of audio and video front ends and other kinds of information and entertainment products. Such techniques are implemented in computer software for picture editing as most PC color monitors meanwhile have the same color gamut and non-linear transfer functions as a TV set, because consumer electronics and computer electronics become more and more connected to each other.

### BRIEF DESCRIPTION OF THE DRAWINGS

For a more complete understanding of the invention, reference should be made to the accompanying drawing, wherein:

FIG. 1 is a schematic diagram of a location of the EqualRGBmax color saturation control;

FIG. 2 is a graph of RGBmaxsat′ values of 30 preferred border reference colors after a camera gamma of 1/2.3 and a saturation control of 1.4;

FIG. 3 is a graph of AverageRGBmax curves of the 30 border reference colors of FIG. 2 as a function f(RGBmax) and f(sat) for an exponential camera gamma;

FIG. 4 shows a projection of a 3D-graph demonstrating UCS1976 and Chrominance” analysis of the EqualRGBmax color saturation control for a preferred color bar test picture at a saturation control of 1.2;

FIG. 5 shows a projection of a 3D-graph demonstrating a calculation of the AverageRGBmax value of an arbitrary color C;

FIG. 6 is a flow chart of a first preferred embodiment of the EqualRGBmax method as a function of the color saturation control;

FIG. 7 is a first graph of AverageRGBmax curves to demonstrate the limiting of the calculated AverageRGBmax′ value to a maximum of 1.067 as a function of a color saturation control of 1.0 to 2.0;

FIG. 8 is a second graph of AverageRGBmax curves to demonstrate the limiting of the calculated AverageRGBmax′ value to a maximum of 1.0 as a function of a color saturation control of 1.0 to 2.0;

FIG. 9 shows a projection of a 3D-graph of test data—on the left: a side projection of data resulting from a conventional saturation control method in UCS1976 and Chroma color space—on the right: a side projection of data from a preferred embodiment of the EqualRGBmax color saturation control method wherein other parameters are the very same as on the left;

FIG. 10 shows a projection of a 3D-graph of test data after the display—as in FIG. 9 on the left: resulting from a conventional saturation control method—as in FIG. 9 on the right: resulting from a preferred embodiment of the EqualRGBmax saturation control method;

FIG. 11 is a flow chart of a second preferred and modified embodiment of the EqualRGBmax method as a function of the color saturation control in particular forming an alternative to the HSV saturation control;

FIG. 12 shows a 3D-graph of test data—on the left: resulting from a conventional HSV saturation control method—on the right: resulting from a second preferred and modified embodiment of the EqualRGBmax method;

FIG. 13 is a first graph of maximum values of the Ro′, Go′ or Bo′ border colors according to the first preferred embodiment of the EqualRGBmax method when using RGBsat′ with a divider (full curves) and without a divider (dashed curves);

FIG. 14 shows a diagram demonstrating the calculation of the preferred reference points of FIG. 2;

FIG. 15 shows a diagram with the numbers of the preferred reference points of FIG. 14 and FIG. 2.

### DESCRIPTION OF THE PREFERRED EMBODIMENTS

### Introduction

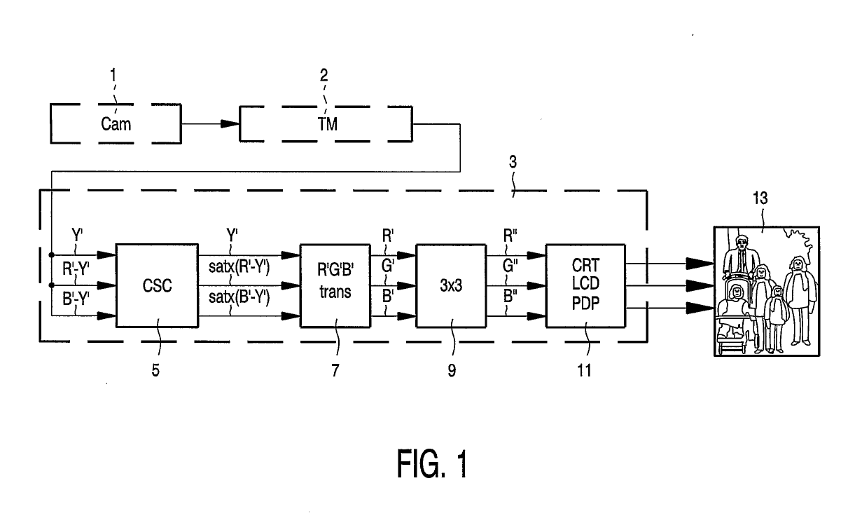

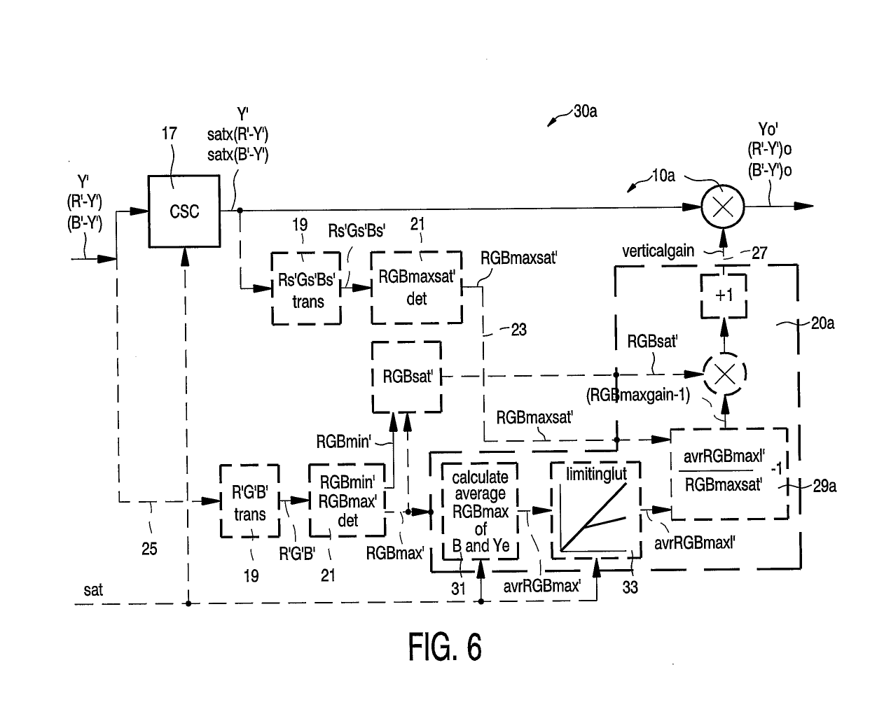

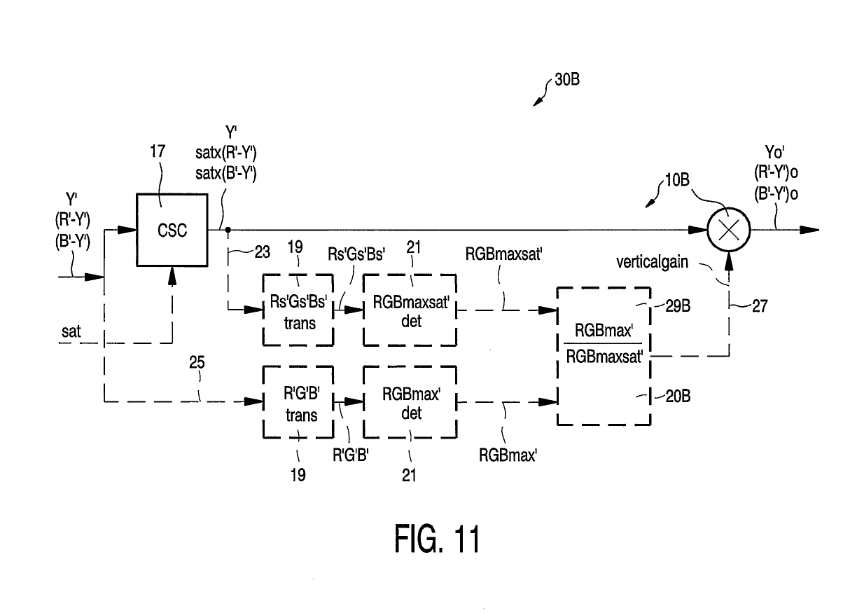

Several methods (30 A in FIG. 6a and 30 B in FIG. 11) are described to maintain a color maximum value in an image or a scene 13 at the output of a display apparatus 3 (TV set, monitor, printer, computer, audio/video applications) as e.g. shown in FIG. 1 at an increased color saturation control (i.e. a saturation value “sat” is larger than unity).

A color saturation control (CSC) in a display apparatus 3 e.g. in television sets or digital still and video camera's or many computer applications or printers is executed preferably in the non-linear signal domain after a non-linear conversion of an original image signal in the camera 1 which registers the video or still pictures. Such non-linear conversion usually is performed by applying a non-linear transfer-function to the signal which will be simply referred to as “gamma” or sometimes “degamma” in case of an inverse non-linear transfer function. In combination with the non-linear gamma of the display means 11 a shown in FIG. 1 preferably an increase of the color saturation above unity is intended.

This non-linear camera signal is the reason why an increasing saturation control results in the display of exaggerated colors, especially the blue, red and magenta colors. For instance the blue colors may be exaggerated at a factor of nine as compared to the yellow colors. On the opposite an increase of the conventional color saturation control offers a very poor yellow color reproduction as well as an insufficient increase of the green and magenta colors.

The location of the color saturation control (CSC) 5 of the display apparatus 3 is according to FIG. 1. Therein a basic diagram of a television system consisting of three main parts 1 , 2 and 3 is shown. On the top a camera 1 and a transfer medium 2 is shown and at the bottom a display apparatus 3 in form of a television display with a CRT (cathode ray tube) or another kind of display means 11 (like a Plasma Display Panel PDP or a Liquid Crystal Display LCD) is shown.

Usually a scene is registered by the camera 1 via a lens and a single light sensitive area image sensor, having a RGB (Red-Green-Blue) or another kind of color array. Next the RGB signals are offered to a 3×3 camera matrix for fitting the color gamut of the camera to a desired television standard like the EBU-standard (European Broadcasting Unit) or HDTV-standard (High Definition Television).

After the matrix the camera gamma is applied. It is intended for compensating the non-linear transfer of the display means 11 (CRT, PDP, LCD) at the end of the display apparatus 3.

Finally in the camera 1 the R′G′B′ signals are converted to the Luma signal Y′ and the color difference signals R′-Y′ and B′-Y′, which form the input signal to the display apparatus 3. As an alternative to the camera 1 the input signal (Y′, R′-Y′ and B′-Y′) may be provided also in any other suitable way.

After the conversion the black level can be adjusted by adding a DC-level to the Luma signal Y′. The saturation can be adjusted by multiplying the color difference signal with a proper factor, which will be indicated by “sat” in the figures.

Before the transfer medium 2 a coder can be applied and thereafter a decoder. The type of coder and decoder will depend on the type of the transfer medium 2.

The display 3 at first provides a black level control on the Luma signal Y′ and a color saturation control CSC 5 on the color difference signals R′-Y′ and B′-Y′. At next the signals are converted back to R′, G′, B′ signals again by a transformation 7.

If the color gamut of the display 3 does not correspond with the gamut of the camera (EBU or HDTV) a 3×3 display matrix 9 can be applied in order to minimize color reproduction errors.

Finally there is the display means 11 which shows the scene 13 registered by the camera 1 via its gamma transfer characteristic. It will be understood that a proper choice of the gamma is left up to a particular application. Here, in this context, a CRT gamma of 2.3 is used. Besides a CRT there are other display means 11 possible to be applied like an LCD (Liquid Crystal Display) and a PDP (Plasma Display Panel).

In general with regard to printers it may be relevant, that most printers have adopted the sRGB standard and therefore a gamma with slightly lower exponent than usual, e.g. a gamma with less gain near black than with a truly exponential curve is applied for pictures, e.g. a linear color bar, before printed. For a proper display on a PC monitor also a gamma with a slightly lower exponent than usual may be preferable. Otherwise usually printed figures would be too dark when printed or viewed on a monitor.

### 1. Equal RGBmax at the Display Input and Output as a Function of the Color Saturation Control

For the sake of clarity the EqualRGBmax color saturation control (CSC) 5 will be described for the application in a TV display apparatus 3 of FIG. 1. This does however not exclude that this EqualRGBmax method can be used in digital still and video cameras, in computer hardware and software applications as well as color printers.

The conventional color saturation control amplifies the amplitude of the (R′-Y′) and (B′-Y′) color difference signals:

(R-Y)′=satx(R′-Y′), and

(B-Y)′=satx(B′-Y′), (1)

where the R′ and B′ signals represent the non-linear R and B signals to the power of the camera gamma and the Y′ signal the sum of the R′G′B′ signals using the Federal Communications Commission (FCC) weights as in the following relation:

Y′=Y_{R}×R′+Y_{G}×G′+Y_{B}×B′=0.299×R′+0.587×G′+0.114×B′ (2)

In the following a method according to a first (30 A in FIG. 6) and second (30 B in FIG. 11) preferred embodiment of the invention is described. At an increasing color saturation control the symmetry of the 3D color space will be perfectly maintained. The maximum of the three primary RGB colors acts as the vertical dimension of the 3D color space. This method will be referred to as “EqualRGBmax method”. From a perception point of view this “EqualRGBmax method” results in a very well balanced color increase with a natural and simultaneous change of all reproduced colors. In contradistinction a conventional method of saturation control will cause exaggerated and unnatural blue, red and magenta colors, poor cyan and green colors and a very poor yellow color reproduction.

In the following the parameter “RGBmax”′ denotes the maximum signal of the three R′G′B′ colors after the non-linear camera. The parameter “RGBmaxsat”′ denotes the maximum signal of the three Rs′Gs′Bs′ signals after the saturation control.

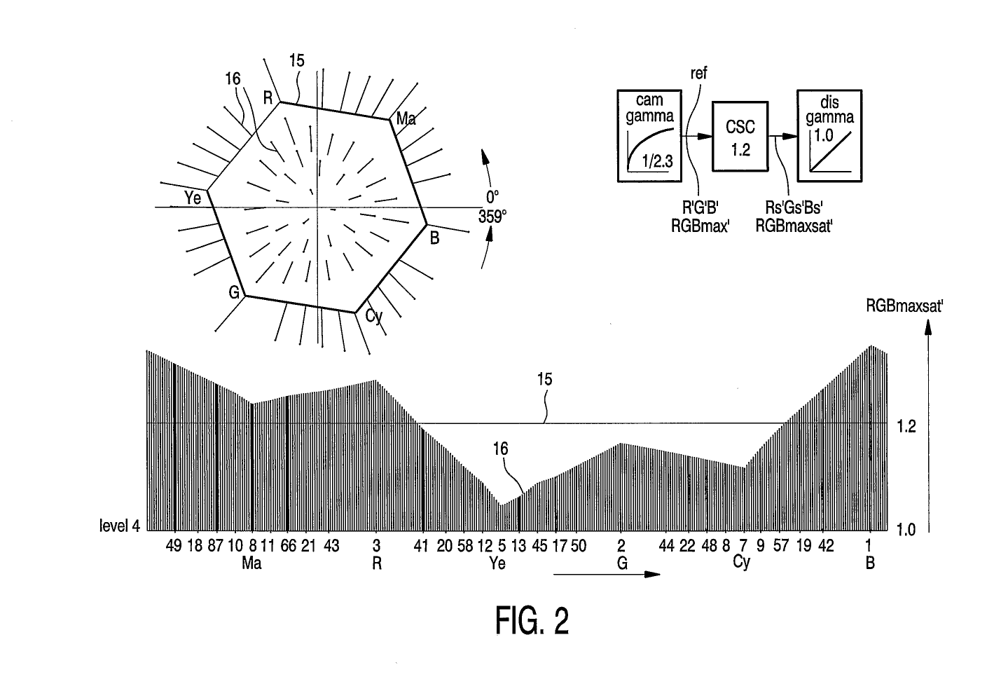

The signals are indicated in the top-right processing icon of FIG. 2. A specific characteristic of the EqualRGBmax saturation control method is that all border colors with the same RGBmax′ input after the camera gamma will get the same RGBmaxsat′ output after the color saturation control and as a consequence also at the output of the display. All colors between the borders and the center white will get an RGBmaxsat′ amplitude proportional to the true color saturation parameter RGBsat′.

### 2. The Principle of the EqualRGBmax Saturation Control

This Sec. 2 refers to a first way of calculating an avrRGBmax value (average RGB-color maximum value) in a preferred embodiment of the EqualRGBmax saturation control method for a defined camera gamma. A first explanation of the basics of the EqualRGBmax saturation control concerns a camera gamma of 1/2.3 and starts with border colors only. A camera gamma of 1/2.3 has been chosen advantageously in order to obtain a unity overall gamma of the camera and the display. The gamma of existing displays is 2.3. I practice a camera and display gamma hardly are exactly complementary. Usually an overall non-linear gamma exists. Nevertheless here a linear light output at the output of the display is achieved, making the color analysis better to understand because a non-linearity of the light output of the display has been prevented.

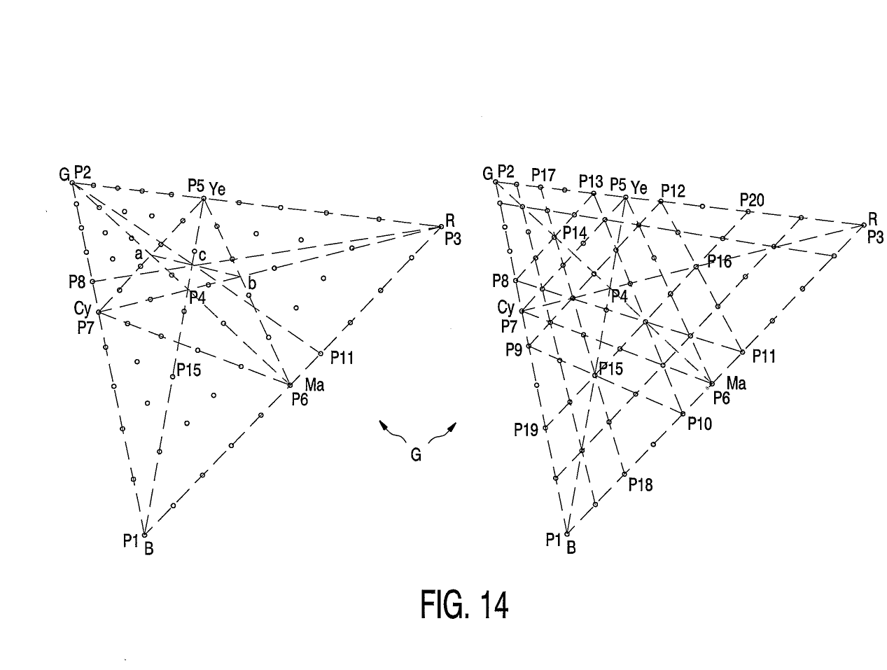

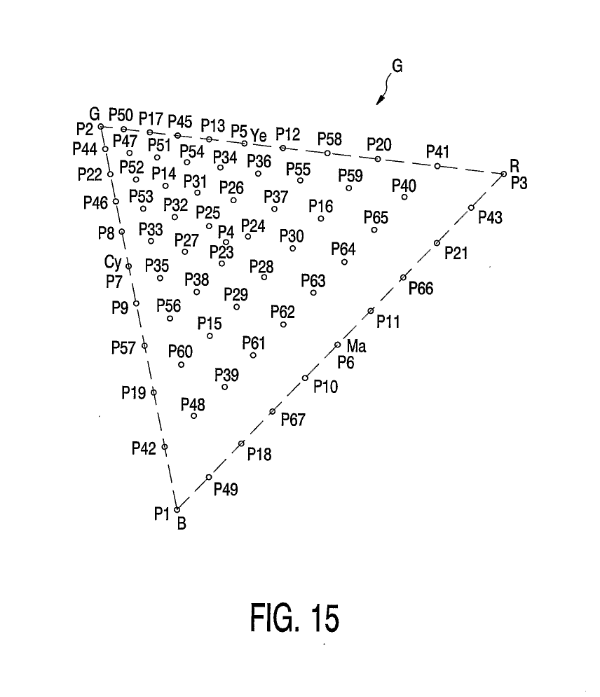

At the top right of FIG. 2 an icon of the conventional saturation control is shown. After the camera gamma the R′G′B′ signals with RGBmax′ as their maximum and after the saturation control the Rs′Gs′Bs′ signals with RGBmaxsat′ as their maximum are indicated. At the bottom of FIG. 2 the increase of the RGBmaxsat′ value of thirty border reference colors is shown by means of the fat fall vertical lines after a saturation control increase to 1.4. The thirty input border reference colors before the saturation control are used as a reference which is indicated by “ref” in the icon of FIG. 2. These have an RGBmax′ value of 1.0 Volt (or 255 in case of 8 bit signals) according to a level 4′ in the 3D-chroma space. The border colors on the bottom-left start from a hue angle of 0 degrees, move to the Ma-R-Ye-G-Cy-B (Magenta, Red, Yellow, Green, Cyan, Blue) colors and finally end at 359 degrees just like it is indicated in the upper-left Chroma plane. On the scale of 0 to 360 degrees also the interpolated RGBmaxsat′ border colors between the border reference points are shown by means of thin dashed vertical lines. On the horizontal scale the reference numbers of a preferred selection of border colors are shown. A preferred way to find the preferred selection is described in detail in the Appendix with reference to FIGS. 14 and 15.

For the 2D Chroma plane the color difference reduction factors according to the second circle approximation are used, so RFRcir2=0.8771 and RFBcir2=0.7277.

The evolution of RGBmaxsat′ 16 in FIG. 2 demonstrates clearly that the blue color B has become the largest amplitude and the from a perception point of view very important yellow (Ye) color has become the smallest amplitude. The horizontal line 15 with a vertical RGBmax′ value of 1.2 (306 for an 8 bit signal) represents the average RGBmax′ value of all thirty border reference colors for a saturation control of 1.4 after a camera gamma of 1/2.3. Using such kind of selected reference colors to determine the average is a first way to calculate the average RGBmax′ value.

When applying the first preferred embodiment of the EqualRGBmax saturation control method as described in the following the RGBmax values of all border colors in FIG. 2 will have become equal to the average RGBmax′ value of 1.2. which is indicated by horizontal line 15. In the following the average value is referred to as avrRGBmax′. To obtain this result the Rs′Gs′Bs′ signals after the saturation control have to be multiplied with a vertical gain parameter called referred to as verticalgain or gain value 27 in the figures and claims:

verticalgain=avrRGBmax′/RGBmaxsat′

The gain value 27 is determined by means of unit 20 A in FIG. 6 according to the first preferred embodiment and by means of unit 20 B in FIG. 11 according to the second preferred embodiment.

With Bs′=sat x (B′-Y′)+Y′ this means for instance that for the blue color B (B=1, R=G=0) the verticalgain=1.2/(sat x (B′-Y′)+Y′)=1.2/(1.4×(1-0.114)+0.114)=1.2/1.354=0.886, results in an attenuation of the amplitude of the blue color B. For the yellow color Ye (R=G=1, B=0) this means that the verticalgain=1.2/(sat x (R′-Y′)+Y′)=1.2/(1.4×(1-0.886)+0.886)=1.2/1.0456=1.1476, results in an amplification of the amplitude of the yellow color Ye. In the case with R′=G′ for the Ye color it does not matter which of the two has been chosen for the calculation of the verticalgain.

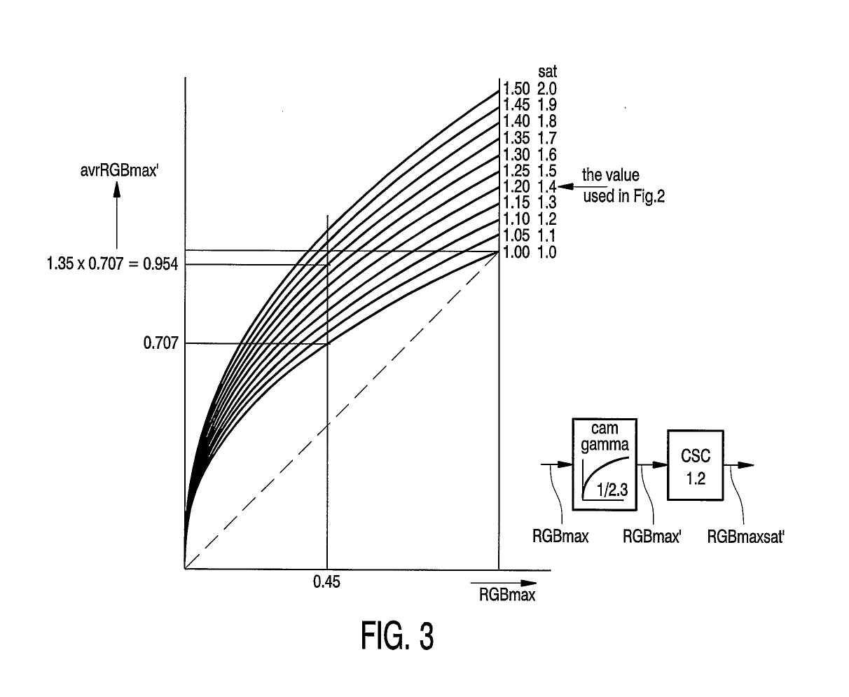

For an arbitrary RGBmax′ value between 0 and 1.0 and an arbitrary saturation control between 1.0 and 2.0 the avrRGBmax′ value can be found as described with reference to FIG. 3. All curves are exponential camera gamma curves with an exponent of 1/2.3. The amplitudes differ as a function of the saturation control column on the right hand side of FIG. 3. If for instance sat=1.7 then the maximum avrRGBmax′ value is 1.35 and the corresponding gamma curve is 1.35×RGBmax^{γ}where γ=1/2.3. For a border color with an RGBmax input of for instance 0.45 this results in:

avrRGBmax′=1.35×0.45^{(1/2.3})=1.35×0.707=0.95

It is to be noted that in case of arbitrary camera gamma curves, having an output of 1.0 Volt at an input of 1.0 Volt, the amplification of the avrRGBmax′ values as a function of the color saturation control is the very same as shown in the table on the right hand side of FIG. 3. This can also be proven, but is not shown here.

For all colors between the borders and the center white of the 3D color space it is possible to obtain a verticalgain which is proportional to the so called true color saturation parameter RGBsat′ of Equ. 8 in the Sec. 3. The verticalgain of an arbitrary color reads:

verticalgain=1+((avrRGBmax′/RGBmaxsat′)−1)×RGBsat′, (3)

where RGBsat′ is measured after the camera gamma and before the saturation control and is equal to zero for white or gray colors and unity for all border colors.

In order to obtain a larger or a smaller amount of verticalgain it is also possible to multiply the result verticalgain with a constant, which can be chosen preferably upon a particular application.

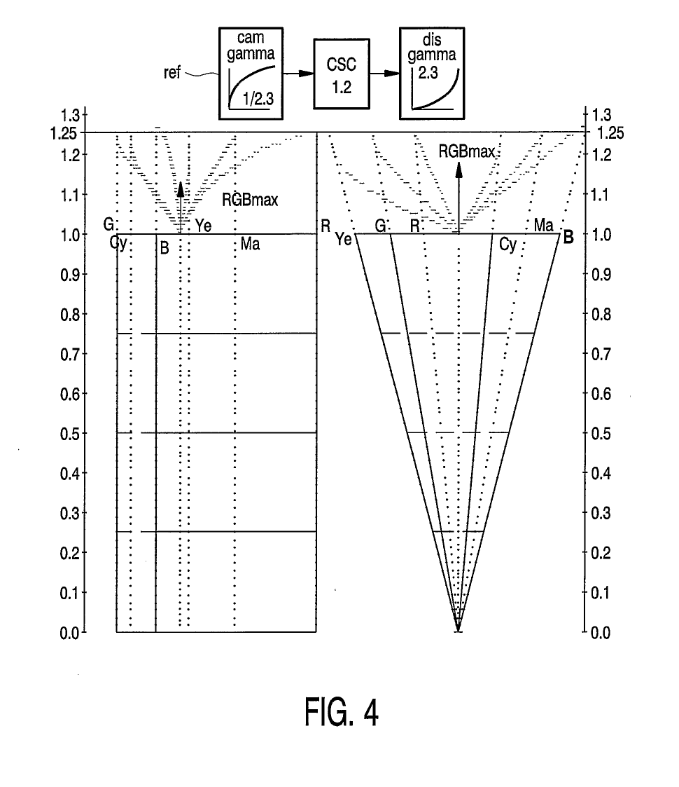

FIG. 4 shows a side projection of a preferred color bar test picture in the UCS1976 and Chrominance” color spaces using this preferred first embodiment of EqualRGBmax saturation control method for a saturation control of 1.2. It refers to a color analysis after the display for a camera and a display gamma having complementary exponents.

It can be clearly seen from FIG. 4 that for the B-R-Ma-G-Cy-Ye border colors the RGBmax″ values after the display are all equal to a value of 1.1^{2,3}=1.25. Also when going from white in the center towards the border colors the proportional increase by means of the RGBsat′ parameter can be seen. In this case of course the RGBmax′ values of all border colors after the saturation control, and before the display, are equal, but then equal to a value of 1.1 corresponding with a saturation control of 1.2.

### 3. The Calculation of the Average RGBmax′ Value of an Arbitrary Color

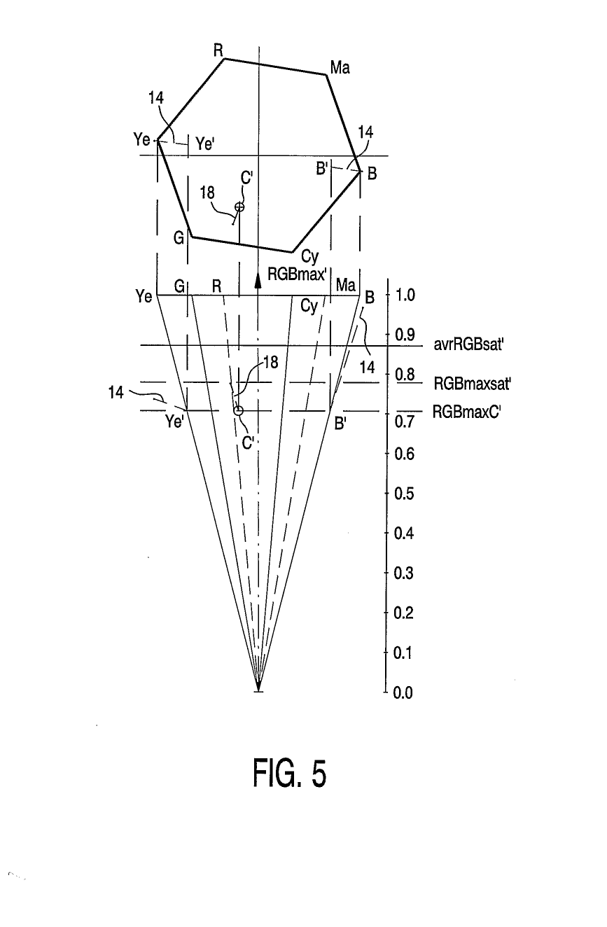

This section refers to a second way of calculating an avrRGBmax value in a preferred embodiment of the EqualRGBmax saturation control method for an unknown camera gamma. The calculation of the avrRGBmax′ value according to the first way in Sec. 2 has been based on the average of thirty border reference points after an arbitrary saturation control larger than or equal to 1.0. According to the second way of Sec. 3 it appears however that calculating the avrRGBmax′ value with the yellow and blue border colors only gives the very same result as with the given thirty border reference colors according to the first way of Sec. 2. The second way makes it rather easy to find the avrRGBmax′ value of an arbitrary color C′ as will be explained with the aid of FIG. 5.

At the top of FIG. 5 the Chroma color plane shows the position of an arbitrary camera color C′. At the bottom of FIG. 5 the color C′ is shown within the side projection of the Chroma color space using the RGBmax′ parameter as the vertical dimension. The RGBmaxC′ value is the maximum of the three R′G′B′ signals determining the color C′. An arbitrary saturation control of 1.4 has been applied of which the resulting color reproduction of the color C′ has been shown by means of the fat full arrow 18 beginning at color C′ at the top as well as at the bottom of FIG. 5. At the bottom side projection also the RGBmaxC′ and RGBmaxsat′ values of the color C′ are shown, being the respectively results before and after a color saturation control of 1.4.

The RGBmaxC′ input value of color C′ is used for defining a yellow color Ye′ with R=G=RGBmaxC′ and B=0, and a blue color B′ according to R=G=0 and B=RGBmaxC′. Those two Ye′ and B′ colors are located at the borders of the 3D Chroma space as can be seen in the side projection. Next the Ye′ and B′ color get the same color saturation of 1.4 as the arbitrary color C′. This is shown at the bottom and also at the top of FIG. 5 by means of the fat full arrows 14 beginning at the RGBmaxC′ level of the Ye′ and B′ colors. Next the average value of both border colors is calculated resulting in the avrRGBsat′ value. By calculating the RGBsat′ parameter of the arbitrary color C′ the desired verticalgain can be found as follows:

verticalgain=1+((avrRGBmax′/RGBmaxsat′)−1)×RGBsat′,

which is the very same as Equ. 3 in the previous Sec. 2.

It is to be noticed that for all colors with the same RGBmax′ value as the RGBmaxC′ value of color C′, also the avrRGBmax′ value calculated via the Ye′ and B′ colors will be the same. The verticalgain for all other colors on the RGBmaxC′ plane as a function of the RGBmaxsat′ and the RGBsat′ parameters will however differ in order to obtain the same avrRGBsat′ level.

### 3.1 The EqualRGBmax Saturation Control Method According to a First Preferred Embodiment

The EqualRGBmax method can be regarded as the maintenance of the RGBmax′ value as a function of the color saturation control before and after the display for all colors in a color plane that have the same RGBmax input value.

In FIG. 6 a block diagram of a first preferred embodiment of the EqualRGBmax method as a function of the color saturation control is shown. With the aid of FIG. 6 the first embodiment of the EqualRGBmax method will be described and elucidated by means of Equ. (4)-(13) and Proc. (9).

In a first processing stream 23 the non-linear camera signals Luma Y′ and the color difference signals (R′-Y′) and (B′-Y′) are offered to the saturation control (CSC) 17 as an input image signal and become respectively Y′ and {sat x (R′-Y′)} and {sat x (R′-Y′)} being the saturation controlled image signal. The Luma and color difference signals with a unity and a modified saturation control are transformed in transforming units 19 to the primary color signals, i.e. the R′G′B′ signals of the camera in a second processing stream 25 and the Rs′Gs′Bs′ signals with a modified saturation control in a first processing stream 23. The “s” in the Rs′Gs′Bs′ signals denotes the modified saturation control in the first processing stream 23.

R′=(R′-Y′)+Y′

G′=(G′-Y′)+Y′, where (G′-Y′)=−(Y_{R}/Y_{G})×(R′-Y′)−(Y_{B}/Y_{G})*(B′-Y′)

B′=(B′-Y′)+Y′ (4)

The Y_{R}, Y_{G} and Y_{B} luminance contributions for obtaining the (G′-Y′) signal are according to the FCC standard of Equ. (2), which is used for the transmission of the Luma signal Y′ and the color difference signals (R′-Y′) and (B′-Y′). This results in Y_{R}:Y_{G}:Y_{B}=0.299:0.587:0.114.
Rs′Gs′Bs′ signals read:

Rs′=satx(R′-Y′)+Y′

Gs′=satx(G′-Y′)+Y′

Bs′=satx(B′-Y′)+Y′ (5)

In Equ. (5) the (G′-Y′) signal of the previously obtained G′ signal of Equ. (4) has been used. The RGBmaxsat′ value is detected as a first maximum value in unit 21 of the first processing stream from the Rs′Gs′Bs′ signals by:

RGBmaxsat′=max{Rs′,Gs′,Bs′} (6)

From the original incoming R′G′B′ stream the RGBmax′ as well as the RGBmin′ signals are detected as a second maximum/minimum value in unit 21 of the second processing stream:

RGBmax′=max{R′,G′,B′}, and

RGBmin′=min{R′,G′,B′} (7)

With the aid of RGBmax′ and RGBmin′ the true saturation parameter RGBsat′ is determined in unit 24 by:

RGBsat′=(RGBmax′−RGBmin′)/RGBmax′ (8)

The calculated RGBsat′ parameter of Equ. (8) will be used to obtain a color saturation control that in a 2D horizontal slice of the 3D color space results in an increasing vertical amplitude when going from white in the center towards the border colors of the gamut. A typical evolution of the described increase has been demonstrated in FIG. 4.

For a given RGBmaxsat′ value after the saturation controlled (sat) signal and a RGBmax′ value of the input signal, the most specific function of the EqualRGBmax saturation control will be executed in unit 31, i.e. the calculation of the average RGBmax value with the aid of the primary Blue and the complementary Yellow color.

### Procedure AverageRGBmax (sat, RGBmax′)

{ Calculate the average RGBmax value of the B and Ye color after the saturation control,
given RGBmax' of the actual pixel }
used variables:

| | |
|---|---|
| totalRGBmax' | { sum of the B and Ye RGBmax calculations } |
| Rst', Gst', Bst',Yst' | { temporary RGBY signals for the 6 calculations as f(sat) } |
| (R−Y)'t, (G−Y)'t, (B−Y)'t | { three temporary color difference signals } |
| RGBmaxt' | { temporary RGBmax' for the 6 calculations } |

begin { of procedure AverageRGBmax }
totalRGBmax' = 0
for i = 0 to 2 do
begin { calculate totalRGBmax' of B and Ye colors, given RGBmaxsat' }
case i of
0: {B} Rst' =0, Gst' = 0, Bst' = RGBmax'
1: {Ye} Rst' = RGBmax', Gst' = RGBmax', Bst' = 0
end of i case
Yst' = YR × Rst' + YG × Gst' + YB × Bst' { YR, YG, YB are the FCC luminance weights }
(R−Y)'t = sat × (Rst'−Yst')
(G−Y)'t = sat × (Gst'−Yst') {3 color difference signals after sat control }
(B−Y)'t = sat × (Bst'−Yst')
Rst' = (R−Y)'t + Yst'
Gst' = (G−Y)'t + Yst' {Rst', Gst', Bst' signals after sat control }
Bst' = (B−Y)'t + Yst'
RGBmaxt' = Rst'
if Gst' > RGBmaxt' then RGBmaxt' = Gst' {find RGBmaxt' of Rst', Gst', Bst' signals}
if Bst' > RGBmaxt' then RGBmaxt' = Bst'
{calculate total RGBmax' }
totalRGBmax' = totalRGBmax' + RGBmaxt'
end {of totalRGBmax' calculation }
avrRGBmax' = totaRGBmax' / 2 {average RGBmax' value of B and Ye color}
end {of procedure AverageRGBmax } (9)

At the end of Proc. (9) the avrRGBmax′ signal of unit 31 of FIG. 6 is available. For the time being it is supposed that the so called ‘limitinglut’ of unit 33 in FIG. 6 has been set in the linear mode, so having no effect on the avrRGBmax′ signal. As a consequence for the time being now avrRGBmaxl′=avrRGBmax′

For obtaining an EqualRGBmax′ output signal of the reference border colors or any arbitrary input border color, the parameter RGBmaxgain has to be calculated in unit 29A according to:

$$RGBmaxgain = \frac{avrRGB max {l}^{′}}{RGB max {sat}^{′}} \qquad ( 10 )$$

### The output of unit 29A is RGBmaxgain−1.

The final verticalgain parameter 27 determined by means of unit 20A reads as a function of the color saturation control:

verticalgain=1+(RGBmaxgain−1)×RGBsat′, (11)

which is equal to Equ. (3).
The Luma and color difference output signals become:

Yo′=verticalgain×Y′

(R-Y)′o=verticalgain×satx(R′-Y′)

(B-Y)′o=verticalgain×satx(B′-Y′) (12)

If RGB output signals are desired these reads:

Ro′=verticalgainctrl×Rs′

Go′=verticalgainctrl×Gs′

Bo′=verticalgainctrl×Bs′ (13)

The results of Equ. (13) can be derived from Equ. (12) as follows:

Ro′=(R-Y)′o+Yo′=verticalgain×satx (R′-Y′)+verticalgain×Y′

Go′=(G-Y)′o+Yo′=verticalgain×satx (R′-Y′)+verticalgain×Y′

Bo′=(B-Y)′o+Yo′=verticalgain×satx (B′-Y′)+verticalgain×Y′,

where similar to Equ. (4) the (G-Y)′o signal can be found by:

(G-Y)′o=−(YR/YG)×(R-Y)′o−(YB/YG)*(B-Y)′o ps

Taking the verticalgain parameter 27 apart this gives:

Ro′=verticalgain×(satx(R′-Y′)+Y′)

Go′=verticalgain×(satx(R′-Y′)+Y′)

Bo′=verticalgain×(satx(B′-Y′)+Y′),

which according to Equ. (5) results in Equ. (13).

### 3.2 A simplified avrRGBmax′ Calculation According to a Modified First Preferred Embodiment

Procedure (9) for the calculation of the avrRGBmax′ value in unit 31 can be also worked out as follows:

For the blue color counts:

### Rst′=0, Gst′=0, Bst′=RGBmax′, so

### Yst′=YB×Bst′=0.114×RGBmax′

### As already known after the saturation control the blue signal will be the largest one.

### Therefore:

### RGBmaxt′=Bst′=satx (Bst′-Yst′)+Yst′

By substituting Bst′=RGBmax′and Yst′=0.114×RGBmax′, the RGBmaxt′ signal becomes:

### RGBmaxt′=satx (RGBmax′−0.114×RGBmax′)−0.114×RGBmax′, or

### RGBmaxt′=satx RGBmax′+(1−sat)×0.114×RGBmax′

In a similar way for the yellow border color counts:

### Rst′=RGBmax′, Gst′=RGBmax′, Bst′=0, so

### Yst′=YR×Rst′+YG×Gst′=0.299×RGBmax′+0.587×RGBmax′=0.886×RGBmax′

Already known is that after the saturation control the red or green signal will be the largest one, so:

### RGBmaxt′=Rst′=satx (Rst′-Yst′)+Yst′

By substuting Rst′=RGBmax′and Yst′=0.886×RGBmax′, the RGBmaxt′ signal becomes:

### RGBmaxt′=satx (RGBmax′−0.886×RGBmax′)−0.886×RGBmax′, or

### RGBmaxt′=satx RGBmax′+(1−sat)×0.114×RGBmax′

The average of the blue and yellow border colors after the color saturation reads:

$$avrRGB {max}^{′} = \{ ( sat \times RGB {max}^{′} + ( 1 - sat ) \times 0.114 \times RGB {max}^{′} ) + ( sat \times RGB {max}^{′} + ( 1 - sat ) \times 0.886 \times RGB {max}^{′} ) \} / 2$$

Working this out results in:

$$\begin{matrix}avrRGB {max}^{′} = \{ 2 \times sat \times RGB {max}^{′} + ( 1 - sat ) \times \\ ( 0.114 + 0.886 ) \times RGB {max}^{′} \} / 2 \\ = \{ 2 \times sat \times RGB {max}^{′} + ( 1 - sat ) \times RGB {max}^{′} \} / 2 \\ = RGB {max}^{′} \times \{ 2 \times sat + ( 1 - sat ) \} / 2 , so \\ avrRGB {max}^{′} = RGB {max}^{′} \times ( 1 + sat ) / 2\end{matrix} \qquad ( 14 )$$

### As a result Proc. (9) can be replaced advantageously also by the easy to apply Equ. (14) in unit 31.

### 4. Compression of the Average RGBmax Value

After the calculation of the avrRGBmax′ value in unit 31 of FIG. 6 a limitinglut is applied in unit 33. In case a display means 11, e.g. a CRT or a PDP, does not cause a loss of a colored, in particular blue or red, detail at an increasing conventional color saturation control, then no limitinglut need to be applied in unit 33 for the EqualRGBmax saturation control method. This is because the maximum RGBmax′ value of the EqualRGBmax method 30A of FIG. 6 is lower than those of conventional saturation control methods. LCD display means however have a limited reach of the light output and can cause a loss of colored detail at an increasing conventional or EqualRGBmax color saturation control. Consequently the limitinglut of unit 33 is particularly of interest for LCD applications. The same argument counts when saving digital RGB pictures or video movies with a maximum RGBmax′ signal level of 255 (when 8 bits are used for each color). Even in case of JPEG and MPEG storage with their Luma and color difference signals, it can be important to limit the maximum RGBmax′ signals in order to limit the reach of the color difference signals as well.

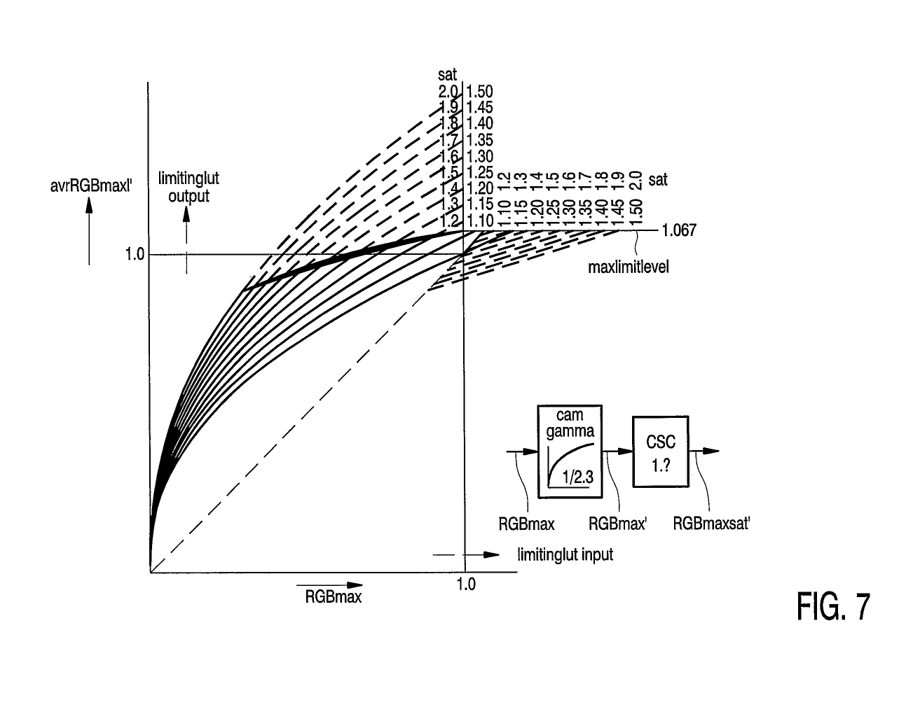

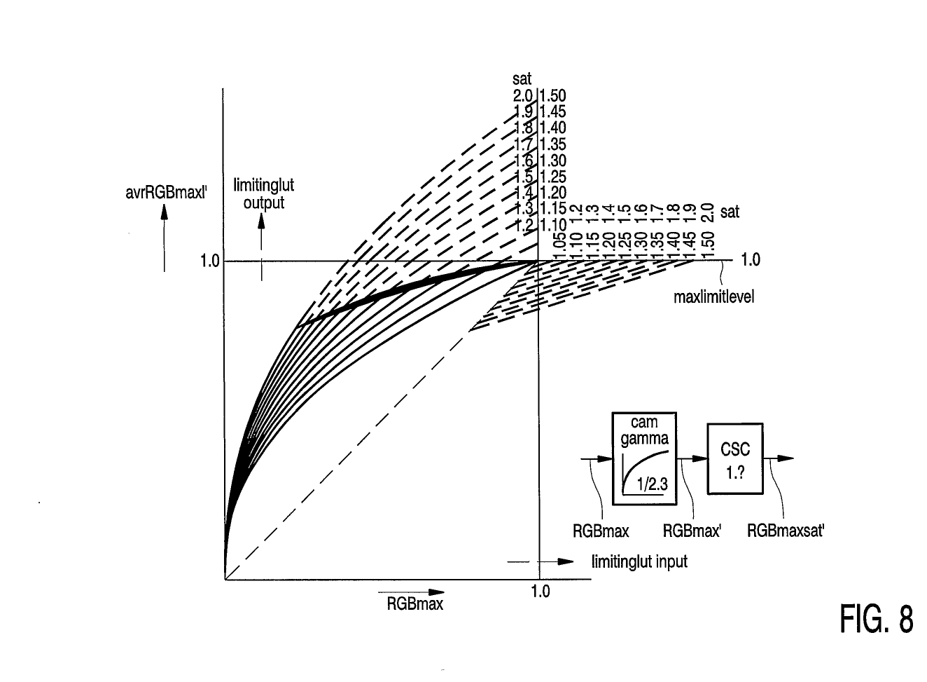

In FIG. 7 and FIG. 8 two examples of limitation of the avrRGBmax′ value are shown. The maximum level of the limitinglut (maxlimitlevel) of FIG. 7 has been set to 1.067, for instance for LCD applications, and of FIG. 8 to 1.0 Volt, for instance for digital storage. It should be noticed that it depends on the amount of saturation of the original picture(s) and the amount of color saturation control where to adjust the maxlimitlevel to. In FIG. 7 and FIG. 8 the limitinglut has been shown by means of fat dashed lines. Below the chosen maxlimitlevel a compression of the avrRGBmax′ value happens in order to maintain some of the colored detail. In both of FIG. 7 and FIG. 8 the amount of compression is chosen with a slope of 0.3. Until the compression starts the transfer of the limitinglut is linear. As can be seen, the limitinglut is a function of the adjustment of the color saturation control value sat. In FIG. 7 nine fat dashed compression curves can be seen for a saturation control varying from sat values of 1.1 to 2.0 (10 steps of 0.1). The first saturation control value of 1.1 does not cause any compression because its avrRGBmax′ value does not reach the maxlimitlevel of 1.067. For a saturation control of 1.2 some compression happens, which will increase at an increasing saturation control. In FIG. 8 ten dashed fat compression curves of the limitinglut can be seen because even at the first saturation control step of 1.1 the avrRGBmax′ value will supersede the maxlimitlevel of 1.0.

The procedure for obtaining the limitinglut as a function of the saturation control reads as follows:

### Procedure Calculate_Limitinglut (sat, maxlimitlevel)

{ calculate limitinglut as function of sat and given maxlimitlevel }
{ here limitinglut consists of 9 bits with 28-1 (=255) as the equivalent for 1.0 Volt }
constant:

| | |
|---|---|
| slope = 0.3 | { the slope of the compression } |
| used variables: | |
| limitinglut | {loop up table with compression curve } |

begin { of procedure Calculate_Limitinglut }
for i = 0 to 512 do { load maximum limiting level in linear curve }
if i > maxlimitlevel then limitinglut[i] = maxlimitlevel else limitinglut[i] = i
Procedure AverageRGMax (sat, 1.0) { calculate avrRGBmax' value of Ye and B color }
{Given avrRGBmax' as f(sat) calculate compression part of limitinglut }
for i=avrRGBmax' downto 0 do
{for the limited curve counts: y=maxlimitlevel + 0.3*i
if (maxlimitlevel−(slope × (avrRGBmax' − i))) < limitinglut[i] then
limitinglut[i] = maxlimitlevel − slope*(avrRGBmax' − i)
end { of procedure Calculate_Limitinglut } (15)

### By substituting a maxlimitlevel of 1.067 and a saturation control range of 1.1 to 2.0 the dashed limitingluts of FIG. 7 are obtained, while for a maxlimitlevel of 1.0 this results in FIG. 8.

The full fat curves in the FIG. 7 and FIG. 8 show the compression in case of a camera gamma of 1/2.3, while the thin dashed curves show the avrRGBmax′ without limitinglut just like already has been shown in FIG. 3.

It is to be noticed that the maximum output of the fat dashed limitinglut curves as a function of the range of the saturation control of 1.1 to 2.0 corresponds with the maximum of the thin dashed curves using no limitinglut. After the limitinglut all the thin dashed curves are limited to the full fat ones at the chosen maxlimitlevel.

With a nine bit limitinglut the maximum applicable avrRGBmax′ level is 511, corresponding with 2.0 Volt that will be reached at a saturation control set to 3.0. Such a high saturation control will hardly happen in practice, so one extra bit for the limitinglut with reference to the signal processing will be sufficient.

### 5. Color Analysis of the EqualRGBmax Color Saturation Control Method

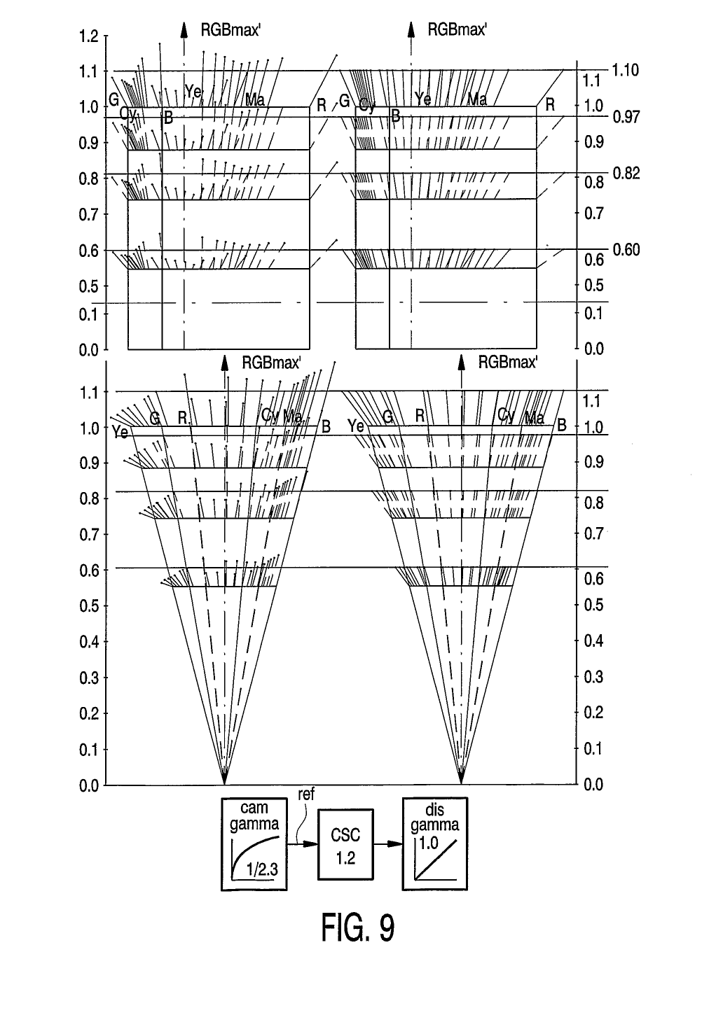

In FIG. 9 the results of the first preferred embodiment of the EqualRGBmax saturation control method can be compared with the results of a conventional saturation control. An icon indicates the location of the signals. The color reproduction in FIG. 9 concerns the border colors only of which the results are shown before the display. The saturation control has been set at a value of 1.2. On the left hand side the results of the conventional saturation control method is shown and on the right hand side the results of the EqualRGBmax method. At the top the results of both methods in the UCS1976 color space can be compared, at the bottom those of the Chroma color space. The poor yellow color reproduction in combination with the exaggerated blue and red colors of the conventional color saturation control have become perfectly balanced in case of the EqualRGBmax method.

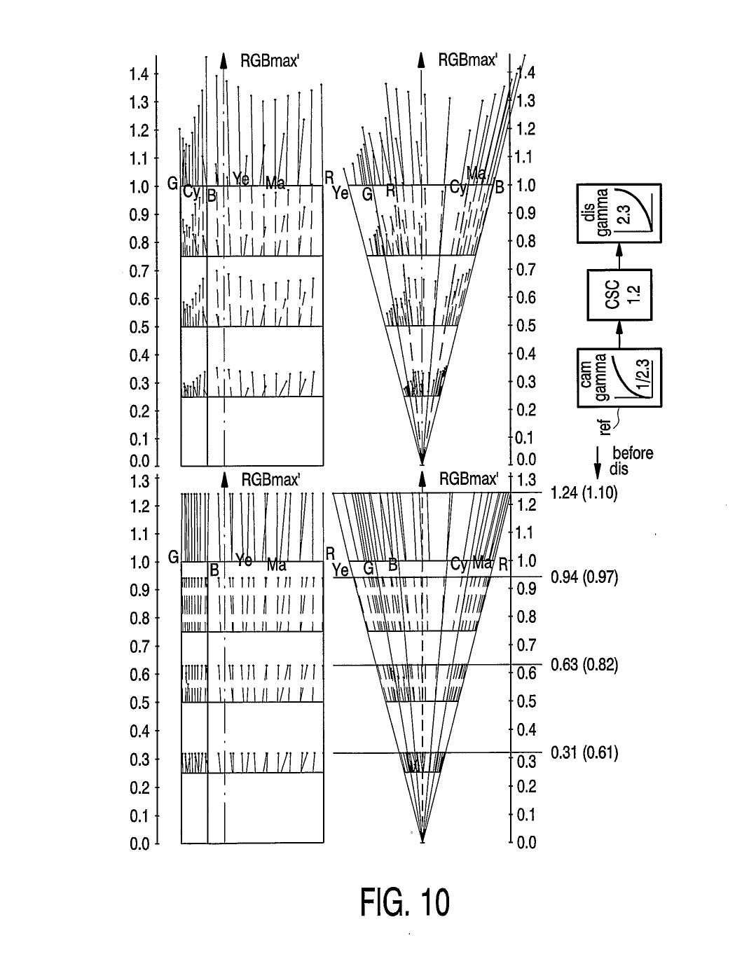

In FIG. 10 the side projection of the border colors in the UCS1976 (left) and Chrominance” (right) color space, with RGBmax″ as a vertical parameter, is shown at the output of the display. An icon indicates the location of the signals. At the top the results of the conventional color saturation control method are shown while at the bottom the results of the EqualRGBmax method are shown. Here again the exaggerated blue and red colors of the conventional color saturation control are limited to the avrRGBmax″ value while the poor yellow color reproduction have been very much enhanced.

Also a side projection of the 3D Luma color space before the display, again using border colors but with an RGBmax′ value that is equal to 1.0 Volt, using a side projection of the UCS1976 space and a side projection of the Chroma space can be analyzed, however, is not shown here. With a saturation control of 1.2 for both, the conventional saturation control method and the EqualRGBmax method, their Luma reproductions can be very well compared. In case of the conventional saturation control the Luma output before the display will be maintained. Therefore the Luma increase or decrease of the EqualRGBmax saturation method can be very clearly seen. Above a Luma output level of about 0.5 the Luma signal of the border colors will increase while they decrease below that level.

An analysis of the UCS1976 and Chrominance” side projection of the Luminance” color space demonstrates the latter border colors at the output of the display as follows: Clearly the large increase of the yellow light output can be seen as well as the reduction of the primary blue and red light output.

It is also proven by analysis of a color bar test picture with a camera gamma of 1/.23 and a maximum amplitude of 0.8 in order to prevent limiting of the maximum signals after a color saturation control of 1.4, that the conventional saturation control has exaggerated blue and red colors and relatively poor yellow color reproduction. The EqualRGBmax saturation control method however has a very well balanced color reproduction. None of the colors is exaggerated neither poorly reproduced. It perfectly behaves like a natural colorful picture.

Also an analysis of the EqualRGBmax color saturation control method, but then with the limitingluts of FIG. 7 and FIG. 8 respectively has been made using a color bar picture, representing a result of an LCD output or a file to be stored. Compared with the unlimited EqualRGBmax picture, the luminance loss in the middle regions of both limitinglut pictures can be seen. However, compared with the unlimited, conventional picture the two limited EqualRGBmax pictures still show a better average yellow color reproduction and remain well balanced. It is noticed that the original picture with a saturation control of 1.0 also is a perfect balanced color picture.

### 6. Modified EqualRGBmax Saturation Control Method According to a Second Preferred Embodiment as an Alternative for HSV Saturation Control

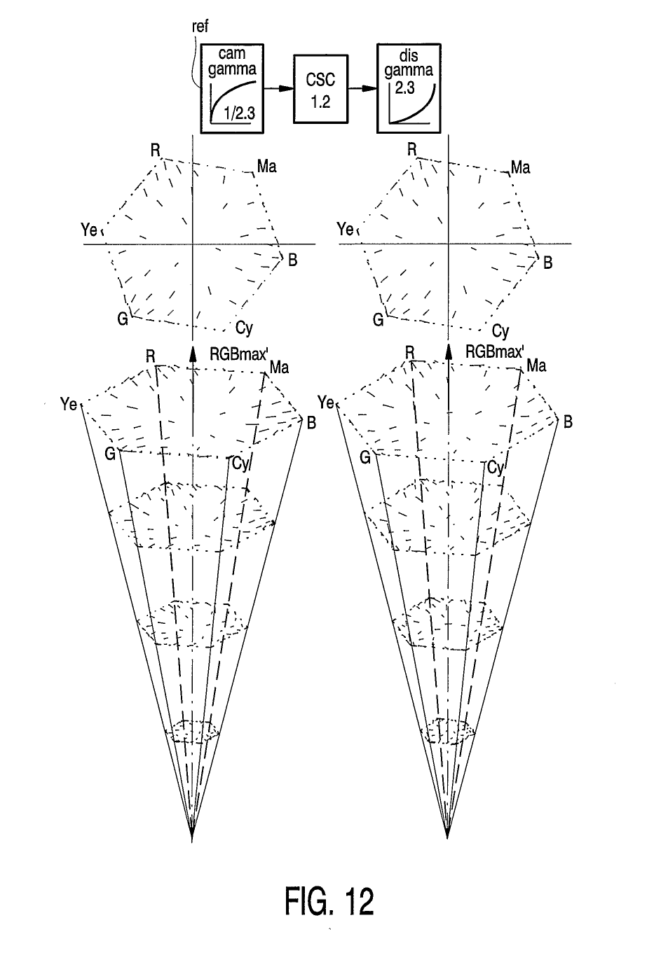

In FIG. 11 a modified second preferred embodiment of the EqualRGBmax method is shown that can act as an alternative for the HSV (Hue-Saturation-Value) color saturation control. In FIG. 12 the color reproduction of both alternatives can be compared.

Although the EqualRGBmax saturation control differs from the HSV one, almost the same color restoration as of HSV can be obtained by applying a verticalgain equal to:

verticalgain=RGBmax′/RGBmaxsat′

### This allows an easy-to-use alternative for the HSV saturation control.

### In FIG. 11 the blockdiagram of this second preferred embodiment of EqualRGBmax method is shown.

In FIG. 12 the results of the first embodiment HSV and this second embodiment EqualRGBmax alternative can be compared. The result of a first embodiment of a HSV saturation control is shown on the left hand side of FIG. 12. The advantage of the second embodiment of the EqualRGBmax method at the right hand side of FIG. 12 is, that no RGB to HSV and no HSV to RGB conversions are needed, making the realization of an HSV kind of saturation control much easier.

Though the advantage of the first and second embodiments prevail upon increasing saturation the EqualRGBmax method with a decreasing color saturation control is much less interesting because the yellow colors decrease too fast in comparison with the conventional saturation control. Except for yellow this also counts, although less dominant, for the near cyan and near green colors.

### 7. Avoiding the Divider for RGBsat′

The EqualRGBmax saturation control method so far requires two dividers: one for the calculation of RGBsat′ and one for RGBmaxgain. Both dividers are needed for the calculation of the verticalgain. Substituting of the Equ. (8) of RGBsat′ and Equ. (10) of RGBmaxgain in Equ. (11) results in:

verticalgainctrl=1+((avrRGBmaxl′/RGBmaxsat′)−1)×((RGBmax′−RGBmin′)/RGBmax′)

There exist practical solutions for the realization of both dividers. Nevertheless it is possible to avoid the RGBsat′ divider by replacing the denominator RGBmax′ by 1.0 [Volt] or by 255 in case of an 8 bit digital signal processing. For the first one (1.0 Volt) this results in:

verticalgain=1+((avrRGBmaxl′/RGBmaxsat′)−1)×(RGBmax′−RGBmin′),

and for the digital method in:

verticalgain=1+((avrRGBmaxl′/RGBmaxsat′)−1)×((RGBmax′−RGBmin′)/255),

where dividing by 255 an be realized by simply shifting the result of the (RGBmax′−RGBmin′) digital value with 8 steps.
The consequences for the verticalgain parameter are as follows:

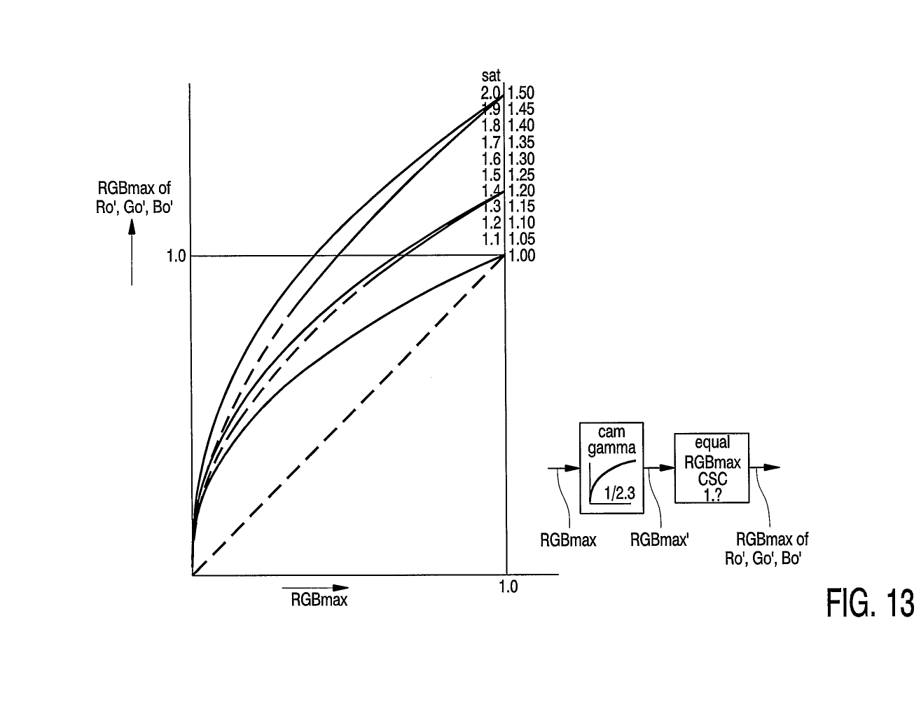

In FIG. 13 the full curves show the differences of the use of a divider as compared to the non-use of a divider for the dashed curves or not for calculation of the RGBsat′ parameter for a saturation control of 1.0, 1.4 and 2.0. As input signal of the curves a linear RGBmax signal has been applied and a camera gamma of 1/2.3, just like in FIG. 3. Instead of the calculated avrRGBmax′ value of the border colors as output parameter, in FIG. 13 the RGBmax value of the Ro′, Go′ and Bo′ border signals of Equ. (13) are shown.

The exchange of the calculated avrRGBmax′ value with the maximum of the Ro′, Go′, Bo′ signals after the EqualRGBmax saturation method mean, that for instance a red primary input color the curves for Ro′ and avrRGBmaxl′ of FIG. 3 should be the same. So:

$$\begin{matrix}{Ro}^{′} = verticalgain \times {Rs}^{′} \\ = ( 1 + ( ( avrRGB max {1}^{′} / RGB max {sat}^{′} ) - 1 ) \times \\ ( ( RGB {max}^{′} - RGB {min}^{′} ) / RGB {max}^{′} ) ) \times {Rs}^{′} \\ = avrRGB max {1}^{′}\end{matrix}$$

### First of all, for a primary red border color counts that RGBmin′=0, so the RGBsat′ parameter (RGBmax′−RGBmin′)/RGBmax′)=1, independent of the RGBmax′ input value.

### Second, for a primary red border color always counts that RGBmaxsat′=Rs′.

Substitution simplifies the above mentioned equation for Ro′ as follows:

Ro′=(1+((avrRGBmaxl′/Rs′)−1)×1)×Rs′,

which can be rewritten to:

Ro′=(avrRGBmaxl′/Rs′)×Rs′=avrRGBmaxl′,

what needed to be shown.

So in FIG. 13 it is justified to use the maximum of Ro′, Go′, Bo′ as the vertical output parameter, where the full curves represent that output for RGBsat′=(RGBmax′−RGBmin ′)/RGBmax′)=1. The dashed curves represent the Ro′Go′Bo′ output for RGBsat′=(RGBmax′−RGBmin′), being unequal to unity, except for an RGBmax input signal of 1.0. In practice the differences between an EqualRGBmax color saturation control according to the full and dashed curves seem to be very well acceptable.

### Appendix—Calculation of the Reference Points

Preferred reference points can be found by drawing specific lines and then calculating their intersection points as shown in FIG. 14. This calculation method of the reference points has the advantage that it is independent of the applied color plane. Here the 2D UCS1976 plane for the FCC primaries has been used because it has the largest color gamut G, offering the best visualization of the drawn lines.

On the left side of FIG. 14 the points P1, P2, P3 and P4 are the known primaries B-G-R and the color white, here White C, but D65 white is allowed as well. By drawing lines from the primaries through white the complementary colors P5, P6, P7 are found (Yellow, Magenta, Cyan). The lines of gamut P5-P6-P7 cross the complementary lines P2-P6, P3-P7, P1-P5, resulting in intersection points a and b. Line a-b crosses line P1-P5 in point c. Line P3-c crosses the BG-line (line 1-2) in reference point P8. Line 2-c crosses the BR-line (line P1-P3) in reference point P11. In a similar way, via gamut P5-P6-P7 etc., the reference points P9, P10, P12 and P13 can be found, as shown on the right hand side of FIG. 14.

The lines P8-P13 and P2-P6 on that side offer reference point P14, lines P9-P10 and P1-P5 offer point P15, while line P11-P12 offers point P16. Line P14-P15 offers the points P17 and P18, line P15-P16 the points P19 and P20, and so on, until all 67 points are found. All 67 reference points are shown in FIG. 15 with their corresponding number.

In Table 1 the corresponding RGB-values of all 67 reference points are shown. They are expressed in relative voltages with at least one primary 1.0000 Volt.

TABLE 1
The RGB voltages of all reference points.

| nr | R (V) | G (V) | B (V) |
|---|---|---|---|
| P1 | 0.0000 | 0.0000 | 1.0000 |
| P2 | 0.0000 | 1.0000 | 0.0000 |
| P3 | 1.0000 | 0.0000 | 0.0000 |
| P4 | 1.0000 | 1.0000 | 1.0000 |
| P5 | 1.0000 | 1.0000 | 0.0000 |
| P6 | 1.0000 | 0.0000 | 1.0000 |
| P7 | 0.0000 | 1.0000 | 1.0000 |
| P8 | 0.0000 | 1.0000 | 0.6667 |
| P9 | 0.0000 | 0.6667 | 1.0000 |
| P10 | 0.6667 | 0.0000 | 1.000 |
| P11 | 1.0000 | 0.0000 | 0.6667 |
| P12 | 1.0000 | 0.6667 | 0.0000 |
| P13 | 0.6667 | 1.0000 | 0.0000 |
| P14 | 0.3333 | 1.0000 | 0.3333 |
| P15 | 0.3333 | 0.3333 | 1.0000 |
| P16 | 1.0000 | 0.3333 | 0.3333 |
| P17 | 0.2500 | 1.0000 | 0.0000 |
| P18 | 0.2500 | 0.0000 | 1.0000 |
| P19 | 0.0000 | 0.2500 | 1.0000 |
| P20 | 1.0000 | 0.25000 | 0.0000 |
| P21 | 1.0000 | 0.0000 | 0.2500 |
| P22 | 0.0000 | 1.0000 | 0.2500 |
| P23 | 0.7500 | 0.7500 | 1.0000 |
| P24 | 1.0000 | 0.7500 | 0.7500 |
| P25 | 0.7500 | 1.0000 | 0.7500 |
| P26 | 1.0000 | 1.0000 | 0.5000 |
| P27 | 0.5000 | 1.0000 | 1.0000 |
| P28 | 1.0000 | 0.5000 | 1.0000 |
| P29 | 0.6000 | 0.4000 | 1.0000 |
| P30 | 1.0000 | 0.4000 | 0.6000 |
| P31 | 0.6000 | 1.0000 | 0.4000 |
| P32 | 0.4000 | 1.0000 | 0.6000 |
| P33 | 0.2000 | 1.0000 | 0.8000 |
| P34 | 0.8000 | 1.0000 | 0.2000 |
| P35 | 0.2000 | 0.8000 | 1.0000 |
| P36 | 1.0000 | 0.8000 | 0.2000 |
| P37 | 1.0000 | 0.6000 | 0.4000 |
| P38 | 0.4000 | 0.6000 | 1.0000 |
| P39 | 0.2857 | 0.1429 | 1.0000 |
| P40 | 1.0000 | 0.1250 | 0.1250 |
| P41 | 1.0000 | 0.1111 | 0.0000 |
| P42 | 0.0000 | 0.1111 | 1.0000 |
| P43 | 1.0000 | 0.0000 | 0.1111 |
| P44 | 0.0000 | 1.0000 | 0.1111 |
| P45 | 0.4286 | 1.0000 | 0.0000 |
| P46 | 0.0000 | 1.0000 | 0.4286 |
| P47 | 0.1250 | 1.0000 | 0.1250 |
| P48 | 0.1250 | 0.1250 | 1.0000 |
| P49 | 0.1111 | 0.0000 | 1.0000 |
| P50 | 0.1111 | 1.0000 | 0.0000 |
| P51 | 0.2857 | 1.0000 | 0.1429 |
| P52 | 0.1429 | 1.0000 | 0.2857 |
| P53 | 0.1667 | 1.0000 | 0.5000 |
| P54 | 0.5000 | 1.0000 | 0.1667 |
| P55 | 1.0000 | 0.5000 | 0.1667 |
| P56 | 0.1667 | 0.5000 | 1.0000 |
| P57 | 0.0000 | 0.4286 | 1.0000 |
| P58 | 1.0000 | 0.4286 | 0.0000 |
| P59 | 1.0000 | 0.2857 | 0.1429 |
| P60 | 0.1429 | 0.2857 | 1.0000 |
| P61 | 0.5000 | 0.1667 | 1.0000 |
| P62 | 0.8000 | 0.2000 | 1.0000 |
| P63 | 1.0000 | 0.2000 | 0.8000 |
| P64 | 1.0000 | 0.1667 | 0.5000 |
| P65 | 1.0000 | 0.1429 | 0.2857 |
| P66 | 1.0000 | 0.0000 | 0.4286 |
| P67 | 0.4286 | 0.0000 | 1.0000 |

The relative RGB-voltage contributions of Tab. 1 are calculated as follows:

For each reference point the light contribution of the three primaries has been calculated via the center of gravity law. This light contribution is expressed in three tristimulus values, each being a part of the known tristimulus values of the FCC (or EBU) primaries. It is supposed that the tristimulus values of the RGB-primaries of the reference source, called TRref, TGref and TBref, correspond with 1 Volt each. By dividing the three calculated tristimulus values of each reference point with the corresponding TRref, TGref and TBref, the new relative values are found which can be expressed in voltages too. Those RGB-voltage values represent the relative output voltage of each reference point when using a camera in a linear mode.

The result of the calculation of the relative RGB voltages of the reference points, as shown in Tab. 1, is independent of the color gamut as well as the color plane, in particular independent of the FCC, EBU and HDTV primaries as well as the xy-CIE1931 and u′v′-UCS1960 or UCS1976 color plane. This means that the relative voltages of Tab. 1 can be applied for simulations of the color reproduction with any type of color gamut in any color plane. Because the UCS color planes are derived from the xy-CIE1931 plane the results of Tab. 1 will be the same given a certain color gamut, for example the FCC gamut. It can be also proven, however not shown here, by the center of gravity law that the content of Tab. 1 is independent of the type of color gamut as well.

To summarize, conventional color saturation in a non-linear signal domain may result in exaggerated and unnatural looking colors. The invention proposes an image signal processing method (30A, 30B) of a color saturation control (17) which applies a gain value (27) to the saturation controlled image signal (Y′, satx(R′-Y′), satx(B′-Y′)) in a color restoration (10) which results in an output signal (Yo′, (R′-Y′)o, (B′-Y′)o). The gain value (27) is determined such that a maximum value of a color in the input signal is maintained in the output signal (Yo′, (R′-Y′)o, (B′-Y′)o). Thereby in particular the symmetry of the 3D-color space is maintained, preferably by controlling at least the maximum values of three primary colors (R, G, B) when increasing the saturation. In a preferred configuration the saturation controlled color difference image signals (satx(R′-Y′), satx(B′-Y′)) are transformed to the RGB domain to obtain an RGB measure of the increased saturation. Also the color difference input image signals (R′-Y′, B′-Y′) are transformed to analyze the original level of saturation. On this basis a first (RGBmaxsat′) and a second (RGBmax′) color maximum value are determined and used to determine the gain value (27).

While the invention has been described in detail, the foregoing description is in all aspects illustrative and not restrictive. It is understood that numerous other modifications and variations can be devised without departing from the scope of the invention.

The features disclosed in the foregoing description, in the claims and/or in the accompanying drawings may, both separately and in any combination thereof, be material for realizing further developed configurations of the invention in diverse forms thereof.

Accordingly, the present invention is intended to embrace all such alterations, modifications and variations that fall within the spirit and scope of the appended claims. In particular any reference signs in the claims shall not be construed as limiting the scope of the invention. The wording “comprising” does not exclude other elements or steps. The wording “a” or “an” does not exclude a plurality.

### REFERENCE NUMERALS

1 camera
2 transfer medium
3 display apparatus
5 color saturation control (CSC)
7 transformation
9 display matrix
10 color restoration/multiplying/color restoration means
11 display means, CRT, LCD, PDP
13 scene
14 arrow indicating saturation control for Ye′, B′
15 horizontal line of average RGBmax′ value
16 evolution of RGBmax′ sat
17 color saturation control
18 arrow indicating saturation control for C′
19 R′G′B′-transformation
20A, 20B unit/means for determining the gain value
21 max/min detecting unit
23 first processing stream
24 unit for measure of true saturation RGBsat′
25 second processing stream
27 gain value/verticalgain parameter
29 unit
29A, 29B unit for calculating gain value
30A, 30B EqualRGBmax method/image signal processing method/image signal processing device
31 unit for calculation of average RGBmax value
33 limiting unit
avrRGBmax′ average RGBmax value
G color gamut
maxlimitlevel maximum level of limitinglut
P1, P2, P3, P4 primary colors and white
P5, P6, P7 complementary color
P8, P9, P10 reference point
P11, P12, P13 reference point
P1-P67 reference color
R, G, B primary color
(R′, G′, B′) RGB-image signal
RGBmax, RGBmax′ second maximum value
RGBmaxGain comparison
RGBmaxsat′ first maximum value
RGBmin′ minimum value
RGBsat′ measure of true saturation
(Rs′,Gs′,Bs′) saturation controlled RGB-image signal
sat saturation value
Y′ Luma signal
(Y′, R′-Y′, B′-Y′) input image signal
(Y′, satx(R′-Y′), satx(B′-Y′)) saturation controlled image signal
Ye, B arbitrary color
Ye, Ma, Cy complementary color
(Yo′, (R′-Y′)o, (B′-Y′)o) output signal

1. An image signal processing method (30A, 30B) of controlling a color saturation for an image, the method comprising the steps of:
providing an input image signal (Y′, R′-Y′, B′-Y′);
applying a saturation control (17) to the input image signal (Y′, R′-Y′, B′-Y′) resulting in a saturation controlled image signal (Y′, satx(R′-Y′), satx(B′-Y′));
applying a gain value (27) to the saturation controlled image signal (Y′, satx(R′-Y′), satx(B′-Y′)) in a color restoration (10A, 10B) resulting in an output signal (Yo′, (R′-Y′)o, (B′-Y′)o); wherein
the gain value (27) is determined (20A, 20B) such that a maximum value (RGBmax′) of a color in the input signal (Y′, R′-Y′, B′-Y′) is maintained in the output signal (Yo′, (R′-Y′)o, (B′-Y′)o).

2. The method as claimed in claim 1 characterized in that the maximum value (RGBmax′) is maintained for all colors having a same maximum input value.

3. The method as claimed in claim 1 characterized in that the maximum value (RGBmax′) of one or more selected reference colors (P1-P67) is maintained.

4. The method as claimed in claim 3 characterized in that the one or more selected reference colors (P1-P67) comprise at least three primary colors (R, G, B).

5. The method as claimed in claim 3 characterized in that the one or more selected reference colors (P1-P67) comprise at least three complementary colors (Ye, Ma, Cy).

6. The method as claimed in claim 1 characterized in that the color restoration (10A, 10B) comprises the further steps of:
in a first processing stream (23):
transforming (19) the saturation controlled image signal (Y′, satx(R′-Y′), satx(B′-Y′)) into a saturation controlled RGB-image signal (Rs′,Gs′,Bs′);
determining (21) a first maximum value (RGBmaxsat′) from the saturation controlled RGB-image signal (Rs′,Gs′,Bs′); and
in a second processing stream (25):
transforming (19) the input image signal (Y′, R′-Y′, B′-Y′) into a RGB-image signal (R′,G′,B′);
determining (21) a second maximum value (RGBmax′) from the RGB-image signal (R′,G′,B′).

7. The method as claimed in claim 6 characterized by determining (20A, 20B) the gain value (27, 29A, 29B) from the first maximum value (RGBmaxsat′, 16) and/or the second maximum value (RGBmax′).

8. The method as claimed in claim 7 characterized by determining (20A, Equ. 11, FIG. 6) the gain value (27, 29A) further by means of a measure (21, 24) of true saturation (RGBsat′, Equ. 8).

9. The method as claimed in claim 8 characterized in that the measure (21, 24) of true saturation (RGBsat′, Equ. 8) provides a difference between the second maximum value (RGBmax′) and a minimum value (RGBmin′) from the RGB-image signal (R′,G′,B′).

10. The method as claimed in claim 7 characterized in that the gain value (27, 29B) forms a comparison (RGBmaxGain) of the second (RGBmax′) and the first (RGBmaxsat′) maximum value (Equ. 10, FIG. 11).

11. The method as claimed in claim 7 characterized in that an average (avrRGBmax′, 15) of the second maximum value (RGBmax′) is used instead of the second maximum value (RGBmax′) to determine the gain value (27, 29A).

12. The method as claimed in claim 11 characterized in that the average (avrRGBmax′, 15) is determined (31) from one or more maximum values (RGBmax′) of selected reference colors (P1-P67).

13. The method as claimed in claim 12 characterized in that the one or more selected reference colors (P1-P67) comprises at least three primary colors (R, G, B).

14. The method as claimed in claim 12 characterized in that the one or more selected reference colors comprises at least three complementary colors (Ye, Ma, Cy).

15. The method as claimed in claim 12 characterized in that the one or more selected colors (P1-P67) are selected in a color gamut (G) by means of a sequence of intersecting lines (FIG. 14, FIG. 15).

16. The method as claimed in claim 11 characterized in that the average (avrRGBmax′) is determined (31) from one or more maximum values (RGBmax′) of an arbitrary reference color (Ye, B).

17. The method as claimed in claim 11 characterized by limiting (33) the average (avrRGBmax′, 15) of the second maximum value (RGBmax′).

18. The method as claimed in claim 17 characterized in that the step of limiting (33) is applied as a function of one or more maximum values (RGBmax′) of an arbitrary reference color and/or by an adjustment of the saturation control.

19. The method as claimed in claim 1 characterized in that the gain value (27) is applied by multiplying (10A, 10B) the saturation controlled image signal (Y′, satx(R′-Y′), satx(B′-Y′)) with the gain value (27).

20. An image signal processing device (30A, 30B) for controlling a color saturation for an image, said device comprising:
means for providing an input image signal (Y′, R′-Y′, B′-Y′);
means for applying a saturation control (17) to the input image signal resulting in a saturation controlled image signal (Y′, satx(R′-Y′), satx(B′-Y′));
color restoration means (10A, 10B) for applying a gain value (27) to the saturation controlled image signal (Y′, satx(R′-Y′), satx(B′-Y′)) resulting in an output signal (Yo′, (R′-Y′)o, (B′-Y′)o);
means for determining (20A, 20B) the gain value (27) such that a maximum value (RGBmax′) of a color in the input signal (Y′, R′-Y′, B′-Y′) is maintained in the output signal (Yo′, (R′-Y′)o, (B′-Y′)o).

21. An apparatus (3) comprising a display means (11) and an image signal processing device (30A, 30B), wherein the image signal processing device (30A, 30B) is adapted to perform the method according to claim 1.

22. Apparatus (3) of claim 21 comprising a display means (11) selected from the group consisting of: Cathode Ray Tube (CRT), Liquid Crystal Display (LCD), Plasma Display Panel (PDP).

23. A computer program product storable on a medium readable by a computing device comprising a software code section which induces the computing device to execute the method as claimed in claim 1 when the product is executed on the computing device.
